(19) United States
(12) Patent Application Publication
(10) Pub. No.: US 2026/0081379 A1
(43) Pub. Date: Mar. 19, 2026

(54) CONNECTOR

(71) Applicant: SUMITOMO WIRING SYSTEMS, LTD., Mie (JP)

(72) Inventors: Kazuo NAKAI, Mie (JP); Yukihiro FUKATSU, Mie (JP)

(21) Appl. No.: 19/108,438

(22) PCT Filed: Aug. 17, 2023
(86) PCT No.: PCT/JP2023/029685

§ 371 Date: Mar. 4, 2025

(30) Foreign Application Priority Data
Sep. 5, 2022 (JP) 2022-140684

(51) Int. Cl. H01R 13/42

(52) U.S. Cl. CPC H01R 13/42

(57) ABSTRACT

A connector includes a first housing and a second housing that are fittable together, and a front retainer attached to the first housing. The first housing has a housing body that houses a female terminal fitting therein, the front retainer has a peripheral wall portion that surrounds an outer peripheral surface of the housing body, the second housing has a hood portion that houses the housing body and the front retainer therein, the peripheral wall portion has a plurality of protrusions that contact an inner peripheral surface of the hood portion on an outer peripheral surface thereof, the protrusions are arranged in a pair at positions facing each other across an internal space of the peripheral wall portion on the outer peripheral surface of the peripheral wall portion, and the peripheral wall portion has a bridging portion that extends through the internal space.

### TECHNICAL FIELD

The present disclosure relates to a connector.

### BACKGROUND

Patent Document 1 discloses a configuration in which a tower portion provided on a female housing is covered by a hood portion of a male housing. A front holder is attached to a front end portion of the tower portion. A plurality of outer protrusions are provided on an outer surface of a peripheral wall of the front holder, and inner protrusions are respectively provided on an inner surface of the peripheral wall at positions corresponding to the outer protrusions. This configuration prevents looseness of the female and male housings by the tower portion of the female housing and the hood portion of the male housing respectively contacting the outer protrusions and inner protrusions of the front holder. In addition, configurations disclosed in Patent Documents 2 to 5 are also known as configurations for preventing looseness of female and male housings.

### PRIOR ART DOCUMENT

### Patent Document

Patent Document 1: JP 2008-016262 A

Patent Document 2: JP 2014-059960 A

Patent Document 3: JP 2017-033700 A

Patent Document 4: JP 2008-166046 A

Patent Document 5: JP 2015-220048 A

### SUMMARY OF THE INVENTION

### Problems to be Solved

In the case of Patent Document 1, the outer protrusions and the inner protrusions are arranged back-to-back at appropriate locations on the peripheral wall of the front holder. In a state in which the female housing and the male housing are fitted together, a radially inward compressive force acts on the appropriate locations of the peripheral wall due to contact between the outer protrusions and the hood portion, and a radially outward compressive force acts on the appropriate locations of the peripheral wall due to contact between the inner protrusions and the tower portion. If an excessive compressive force acts on the appropriate locations of the peripheral wall from both radial sides in this way, there is a concern that a portion of the peripheral wall that is continuous with the appropriate locations will deflect so as to absorb the compressive force. Similarly to the front holder, a front retainer with a function of locking terminal fittings may also have a peripheral wall sandwiched between the female housing and the male housing, and protrusions for preventing looseness may be provided on the peripheral wall. In this case, the peripheral wall of the front retainer may also deform under an excessive compressive force.

In view of the above, an object of the present disclosure is to provide a connector that is able ensure rigidity of an attachment member such as a front holder or a front retainer.

### Means to Solve the Problem

A connector of the present disclosure includes a first housing and a second housing that are fittable together and an attachment member attached to the first housing, the first housing having a housing body that houses a terminal fitting therein, the attachment member having a peripheral wall portion that surrounds an outer peripheral surface of the housing body, the second housing having a hood portion that houses the housing body and the attachment member therein, the peripheral wall portion having a plurality of protrusions that contact an inner peripheral surface of the hood portion on an outer peripheral surface thereof, the protrusions being arranged in a pair at positions facing each other across an internal space of the peripheral wall portion on the outer peripheral surface of the peripheral wall portion, and the peripheral wall portion having a bridging portion that extends through the internal space so as to connect the protrusions forming a pair.

### Effect of the Invention

According to the present disclosure, the rigidity of an attachment member can be ensured.

### BRIEF DESCRIPTION OF THE DRAWINGS

FIG. 1 is an exploded perspective view of a connector of a first embodiment.

FIG. 2 is a perspective view of a first housing as viewed from a front lower side.

FIG. 3 is a front view of the first housing as viewed from the front.

FIG. 4 is a rear view of a second housing as viewed from the rear.

FIG. 5 is a perspective view of an attachment member as viewed from a rear right side.

FIG. 6 is a front view of the attachment member as viewed from the front.

FIG. 7 is a sectional view taken along line A-A in FIG. 6.

FIG. 8 is a sectional view taken along line B-B in FIG. 6.

FIG. 9 is a sectional view taken along line C-C in FIG. 8.

FIG. 10 is a side sectional view of the connector of the first embodiment.

FIG. 11 is a sectional view taken along line D-D in FIG. 10.

FIG. 12 is a sectional view taken along line E-E in FIG. 10.

FIG. 13 is a perspective view of a first housing of another embodiment as viewed from the front lower side.

FIG. 14 is a perspective view of an attachment member of the other embodiment as viewed from a rear left side.

### DETAILED DESCRIPTION TO EXECUTE THE INVENTION

### Description of Embodiments of Disclosure

First, embodiments of the present disclosure will be described.

(1) A connector of the present disclosure includes a first housing and a second housing that are fittable together, and an attachment member attached to the first housing, in which the first housing has a housing body that houses a terminal fitting therein, the attachment member has a peripheral wall portion that surrounds an outer peripheral surface of the housing body, the second housing has a hood portion that houses the housing body and the attachment member therein, the peripheral wall portion has a plurality of protrusions that contact an inner peripheral surface of the hood portion on an outer peripheral surface thereof, the protrusions are arranged in a pair at positions facing each other across an internal space of the peripheral wall portion on the outer peripheral surface of the peripheral wall portion, and the peripheral wall portion has a bridging portion that extends through the internal space so as to connect the protrusions forming a pair. With this configuration, the bridging portion is disposed between the protrusions forming a pair, and thus it is possible to avoid a compressive force acting on the peripheral wall portion from the housing body side, which is the side on which the bridging portion is disposed. In addition, the peripheral wall portion can maintain its own rigidity due to the bridging portion between the protrusions provided as a pair. As a result, deflection of the peripheral wall portion can be suppressed.

(2) In the connector of the present disclosure, it is preferable that a plurality of sets of the protrusions forming a pair are provided on the peripheral wall, and the bridging portion is provided corresponding to all the sets of the protrusions forming a pair. With this configuration, deflection of the peripheral wall portion can be more reliably suppressed.

(3) In the connector of the present disclosure, when a fitting direction of the first housing to the second housing is a front-back direction, the protrusions are preferably arranged within a range of a length of the bridging portion in the front-back direction. With this configuration, a compressive force acting on the peripheral wall portion from the hood portion via the protrusions can be reliably borne by the bridging portion.

(4) In the connector of the present disclosure, when a fitting side of the first housing to the second housing is a front side, it is preferable that the attachment member has a front wall portion that covers a front end of the housing body, and the bridging portion extends along a rear surface of the front wall portion and is connected to the rear surface of the front wall portion. With this configuration, the bridging portion is connected to the front wall portion, and thus the strength of the bridging portion can be increased.

(5) In the connector of the present disclosure, the peripheral wall portion has upper and lower walls and left and right walls respectively on upper and lower sides and left and right sides as viewed from a fitting side of the first housing to the second housing. The bridging portion preferably has a first bridging portion bridged in a left-right direction between the left and right walls, and a second bridging portion bridged in an up-down direction between the upper and lower walls. With this configuration, a compressive force acting on the peripheral wall portion from the hood portion via the protrusions can be borne by the first bridging portion and the second bridging portion in the left-right direction and the up-down direction, and deflection of the peripheral wall portion can be more reliably suppressed.

(6) In the connector of the present disclosure, the first bridging portion preferably has a retaining portion that prevents the terminal fitting from coming out of the housing body. With this configuration, the first bridging portion has both a function of reinforcing the attachment member and a function of preventing the terminal fitting from coming out, and thus it is possible to avoid complicating the configuration of the attachment member compared to a case where both functions are provided separately.

(7) In the connector of the present disclosure, it is preferable that the housing body has cavity towers adjacent to each other in the left-right direction, and the second bridging portion is disposed between the adjacent cavity towers. With this configuration, the second bridging portion is disposed between the adjacent cavity towers with good space efficiency.

(8) In the connector of the present disclosure, when a direction in which the protrusions contact the inner peripheral surface of the hood portion is a first direction, and a direction intersecting the first direction is a second direction, the first housing preferably has an inner contact portion that contacts the bridging portion from the second direction. With this configuration, the protrusions restrict looseness between the second housing and the attachment member, and the inner contact portion restricts looseness between the first housing and the attachment member. As a result, looseness between the first housing and the second housing is restricted via the attachment member. In addition, the first direction in which the protrusions contact the inner peripheral surface of the hood portion and the second direction in which the inner contact portion contacts the bridging portion intersect each other. Therefore, an excessive compressive force is not applied to the peripheral wall portion from both sides (first direction and opposite direction thereto) in a thickness direction of the peripheral wall portion, and deflection of the peripheral wall portion can be suppressed. (9) In the connector of the present disclosure, it is preferable that the bridging portion has a plate shape with a plate thickness oriented in a direction intersecting a bridging direction in which the bridging portion connects the protrusions facing each other, and the inner contact portion contacts the bridging portion so as to sandwich the bridging portion from both sides in a plate thickness direction of the bridging portion. With this configuration, looseness between the first housing and the attachment member can be more reliably suppressed without performing any special processing on the bridging portion.

(10) In the connector of the present disclosure, the inner contact portion is preferably disposed adjacent to an inner peripheral surface of the peripheral wall portion. With this configuration, since a position where the inner contact portion contacts the bridging portion can be disposed on an outer edge portion of the first housing, it is easy to suppress looseness of the attachment member with respect to the first housing.

(11) In the connector of the present disclosure, it is preferable that the first housing has a receiving recess that receives the bridging portion between opposing surfaces facing each other, and the inner contact portion protrudes from the opposing surfaces in a direction that narrows an opening width of the receiving recess. With this configuration, by adjusting the amount by which the inner contact portion protrudes, a looseness prevention structure can be formed between the first housing and the attachment member without increasing assembly resistance.

(12) In the connector of the present disclosure, when a fitting side of the first housing to the second housing is a front side, the attachment member is preferably a front retainer having a front wall portion that covers a front end of the housing body. With this configuration, it is possible to obtain a front retainer that is less likely to deflect.

### Detailed Description of Embodiments of Disclosure

### <First Embodiment>

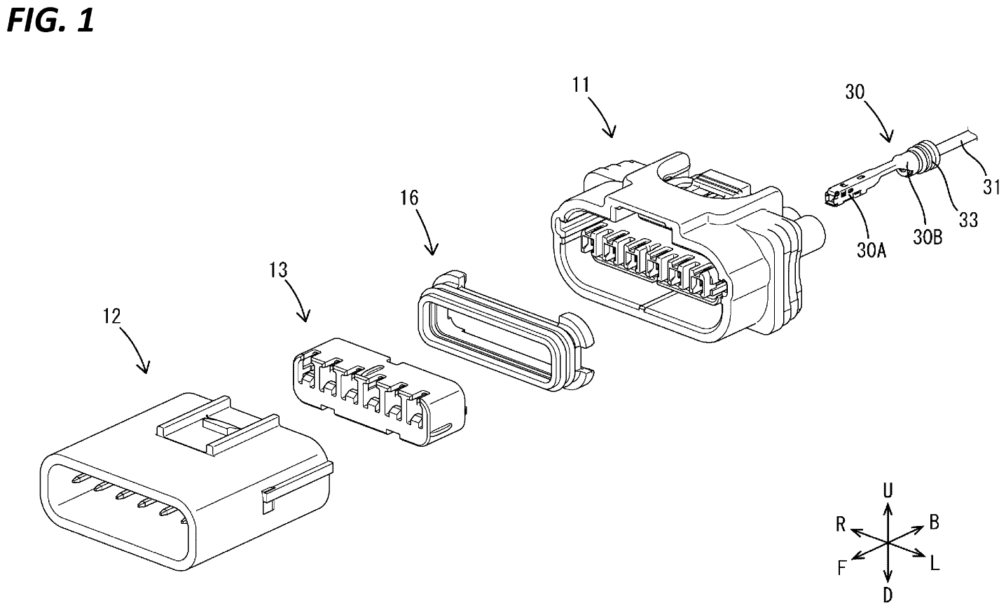

A connector 10 embodying the present disclosure will be described with reference to FIGS. 1 to 12. In the drawings, “front side”, “back side”, “upside”, “downside”, “right side”, and “left side” are respectively represented by “F”, “B”, “U”, “D”, “R”, and “L”. In a first embodiment, the left-right direction corresponds to a width direction. As illustrated in FIG. 1, the connector 10 of the first embodiment includes a first housing 11 and a second housing 12 that are fittable together, and a front retainer 13 which is an attachment member. The front side is the side on which the second housing 12 fits into the first housing 11.

### [Configuration of First Housing]

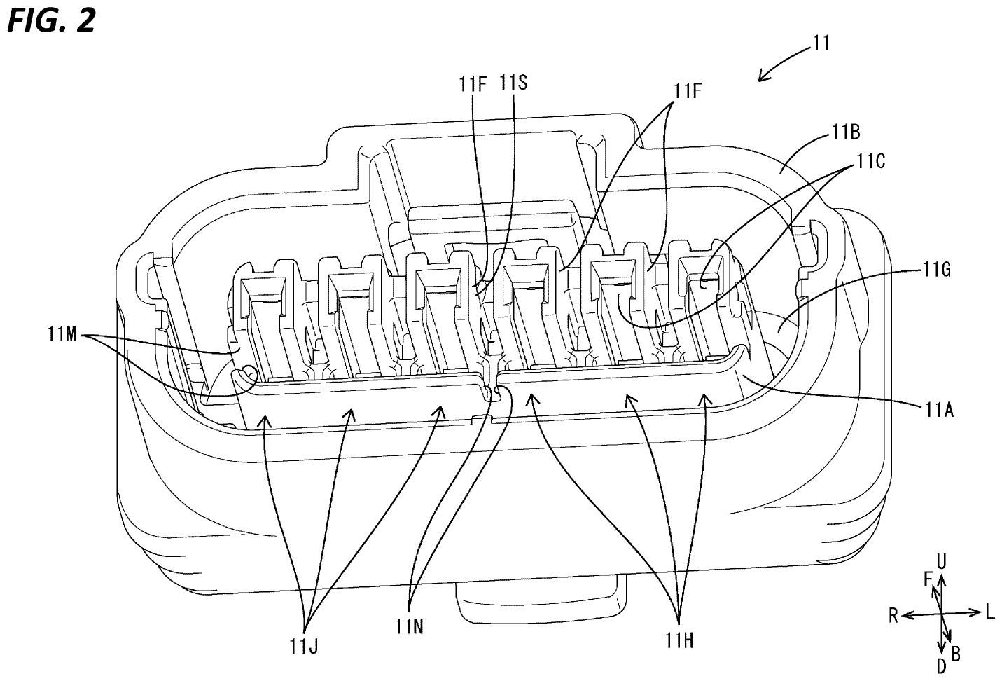

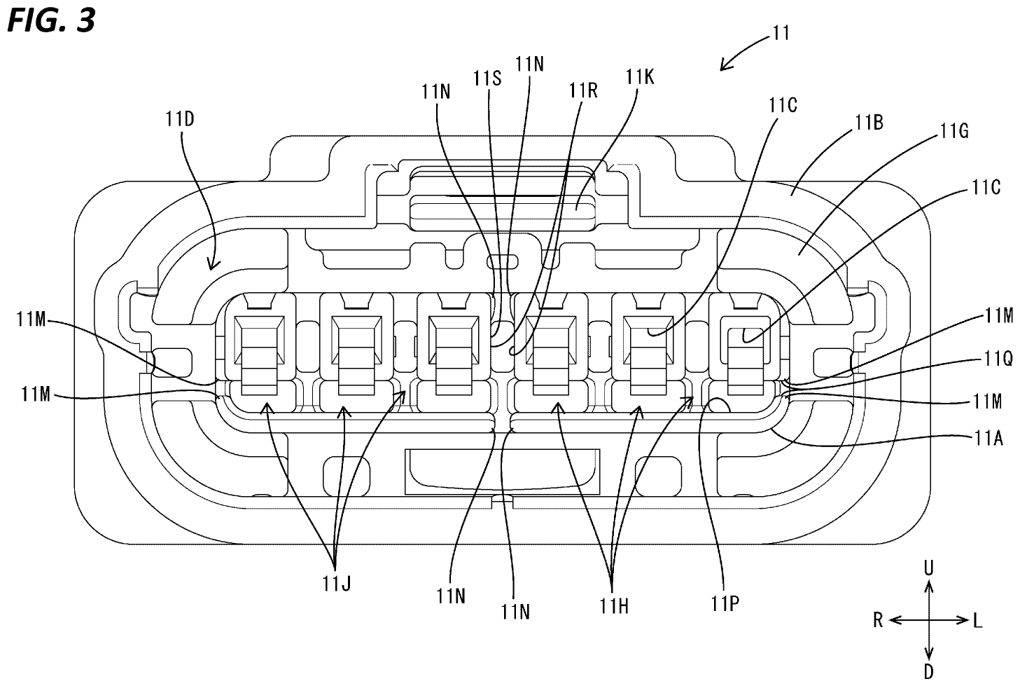

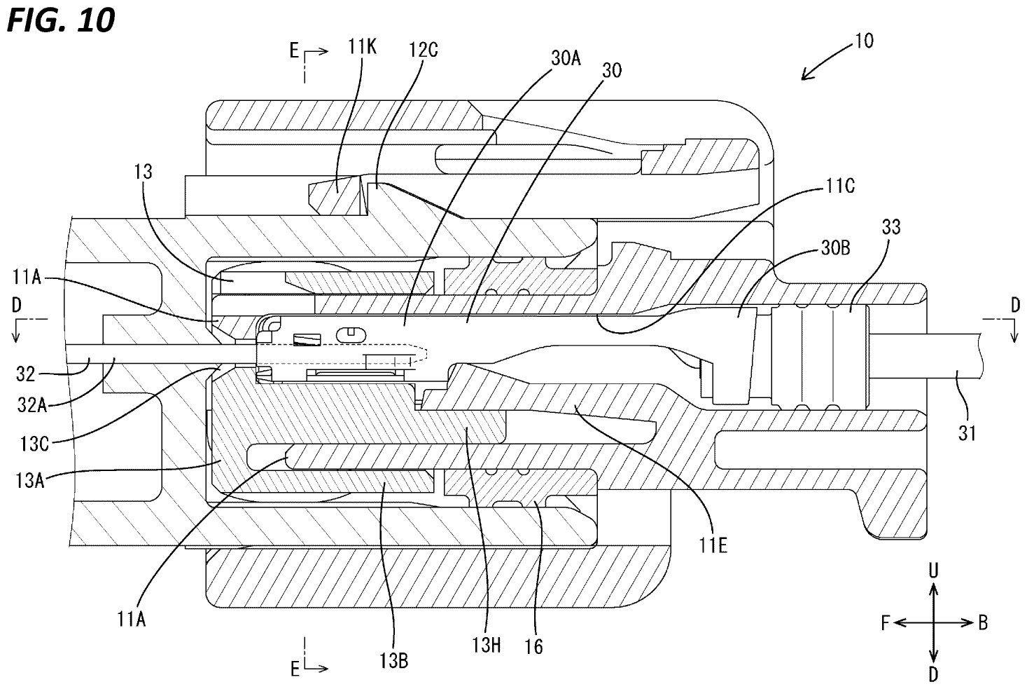

The first housing 11 is made of synthetic resin. The first housing 11 is configured as a female housing capable of housing a female terminal fitting 30 from the rear. As illustrated in FIGS. 2 and 3, the first housing 11 has a housing body 11A that is flat in the left-right direction (width direction) and a tubular surrounding wall portion 11B that surrounds an outer periphery of the housing body 11A. A plurality of cavities 11C that pass through in the front-back direction are formed arranged in the left-right direction in the housing body 11A. A lance 11E extending forward in a cantilever manner is provided on an inner surface of each cavity 11C (see FIG. 10).

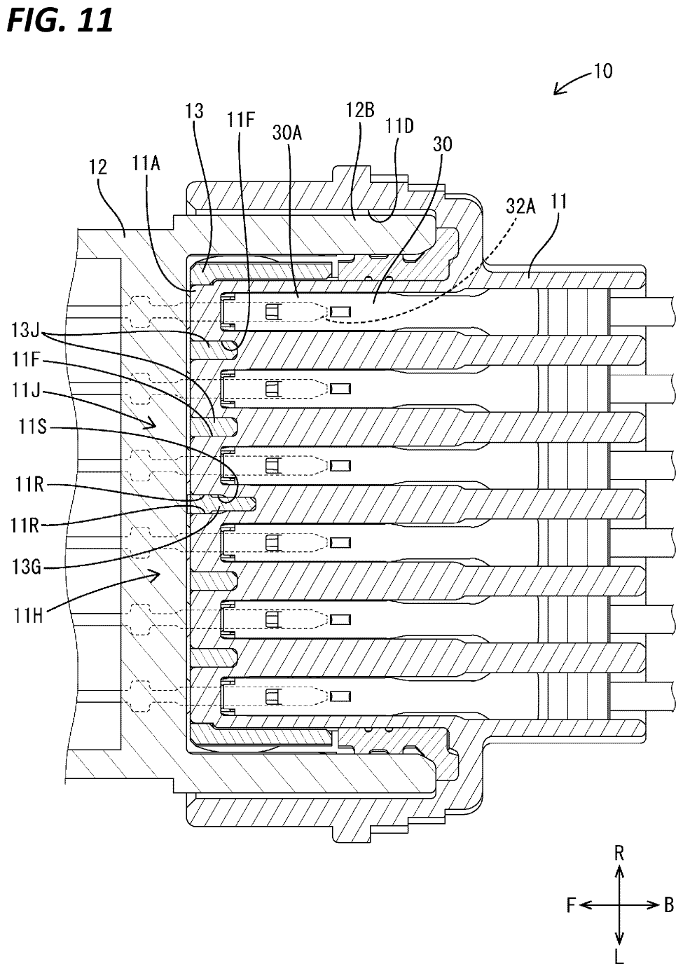

At a front end portion of the housing body 11A, recesses 11F are formed between adjacent cavities 11C. Of the recesses 11F, a recess 11F located at the center in the left-right direction passes through from an upper end to a lower end of the housing body 11A (see FIG. 2) and is formed to be recessed rearward deeper than other recesses 11F (see FIG. 11). The recess 11F located at the left-right center is a second receiving recess 11S that receives a second bridging portion 13G of the front retainer 13 described below. The second receiving recess 11S receives the second bridging portion 13G between opposing surfaces 11R facing each other (see FIG. 11).

As illustrated in FIG. 3, in the housing body 11A, three first cavity towers 11H are arranged in a portion to the left (L side in FIG. 3) of the second receiving recess 11S, and three second cavity towers 11J are arranged in a portion to the right (R side in FIG. 3) of the second receiving recess 11S. The first cavity towers 11H and the second cavity towers 11J are adjacent to each other in the left-right direction. Each of the opposing surfaces 11R facing each other and forming the second receiving recess 11S is provided with a second inner contact portion 11N that is an inner contact portion so as to protrude in a direction narrowing an opening width of the second receiving recess 11S. At an upper end portion and a lower end portion of the opposing surfaces 11R, the second inner contact portion 11N is arranged on each of the opposing surfaces 11R so as to face each other in the left-right direction.

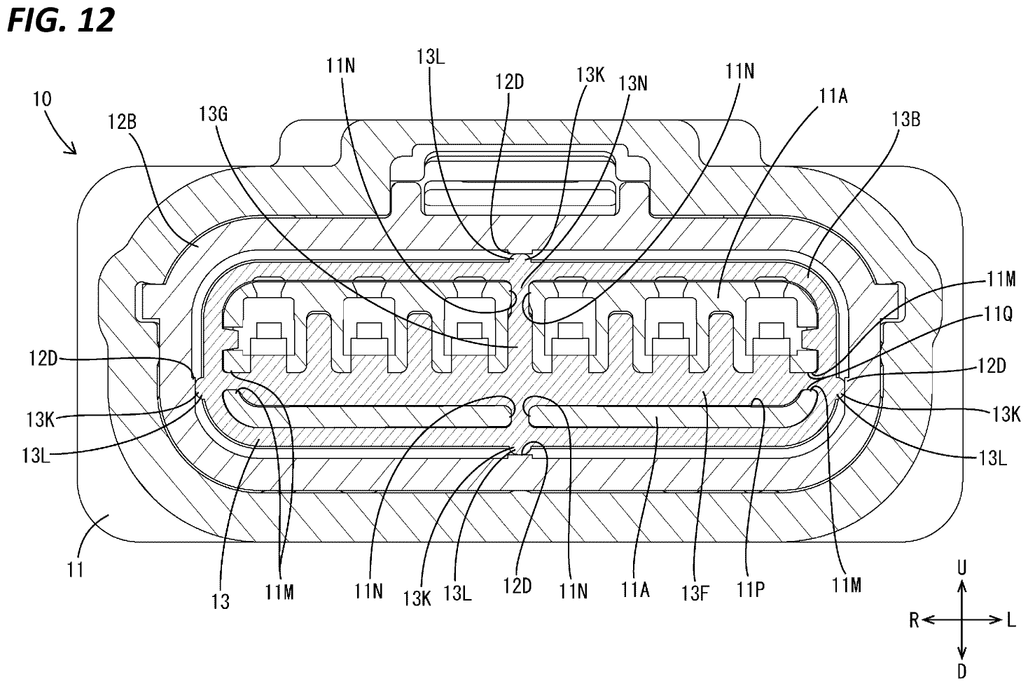

At the front end portion of the housing body 11A, a first receiving recess 11P that passes through from a left end to a right end and is recessed rearward is formed below the first cavity tower 11H and the second cavity tower 11J. The first receiving recess 11P receives a first bridging portion 13F described below between opposing surfaces 11Q facing each other (see FIG. 12). The opposing surfaces 11Q facing each other and forming the first receiving recess 11P are each provided with a first inner contact portion 11M that is an inner contact portion so as to protrude in a direction narrowing an opening width of the first receiving recess 11P. At a left end portion and a right end portion of each opposing surface 11Q, the first inner contact portion 11M is arranged on each of the opposing surfaces 11Q so as to face each other in the up-down direction.

When viewed from the front (fitting side of the first housing 11 to the second housing 12), the surrounding wall portion 11B has a rectangular tubular shape with an upper wall, a lower wall, a left wall, and a right wall respectively on the upper, lower, left, and right sides. A lock arm 11K is provided at a center portion of the upper wall of the surrounding wall portion 11B in the left-right direction. A connecting portion 11G extending inward is provided at a rear end portion of the surrounding wall portion 11B. The connecting portion 11G is connected to the outer peripheral surface of the housing body 11A. A fitting space 11D into which the second housing 12 described below can fit is formed between the surrounding wall portion 11B and the housing body 11A. A ring-shaped seal ring 16 is fitted onto the outer peripheral surface of the housing body 11A in front of the connecting portion 11G (that is, a back part of the fitting space 11D) (see FIG. 10).

The female terminal fitting 30 is inserted into each cavity 11C from the rear. The female terminal fitting 30 is made of a conductive metal. As illustrated in FIG. 1, the female terminal fitting 30 is connected to an end portion of an electric wire 31 and is provided with a rectangular tubular box portion 30A at the front. A tab 32A of a male terminal fitting 32 described later is inserted into and connected to the box portion 30A (see FIG. 10). The female terminal fitting 30 is prevented from coming out of the cavity 11C by the lance 11E being locked onto a rear end of the box portion 30A (see FIG. 10). A rubber stopper 33 is fitted onto the electric wire 31. The rubber stopper 33 adheres to an inner surface of a rear portion of the cavity 11C while being held by a barrel portion 30B of the female terminal fitting 30, and liquid-tightly seals the cavity 11C (see FIG. 10).

### [Configuration of Second Housing]

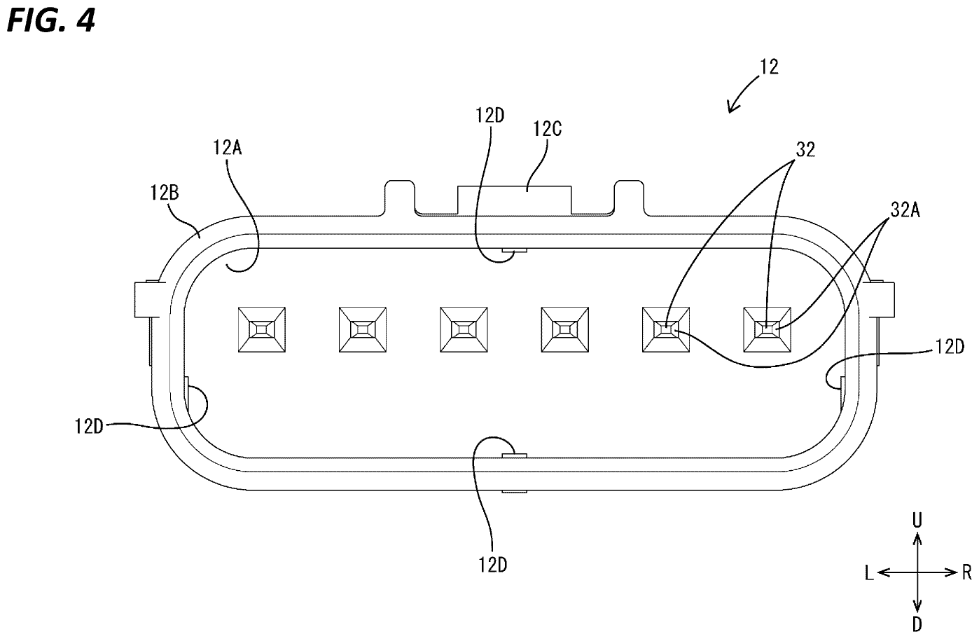

The second housing 12 is made of synthetic resin. The second housing 12 is configured as a male housing to which the male terminal fittings 32 can be attached. As illustrated in FIG. 4, the second housing 12 has a terminal holding portion 12A having a plate shape with a plate thickness direction oriented in the front-back direction, and a hood portion 12B extending rearward from an outer peripheral edge of the terminal holding portion 12A in a rectangular tubular shape. A plurality of the tabs 32A of the male terminal fittings 32 that pass through the terminal holding portion 12A in the front-back direction are arranged protruding in the hood portion 12B. A lock portion 12C is provided protruding upward at the center portion of the upper wall of the hood portion 12B in the left-right direction. The inner peripheral surface of the hood portion 12B is provided with a plurality of contact portions 12D that protrude inward. The contact portions 12D are arranged one on each inner surface of an upper wall, a lower wall, a left wall, and a right wall that constitute the hood portion 12B.

### [Configuration of Front Retainer]

The front retainer 13 is made of synthetic resin. The front retainer 13 is attached to the housing body 11A from the front (see FIG. 10). The front retainer 13 is attached to the housing body 11A and thus functions to prevent the female terminal fitting 30 from coming out.

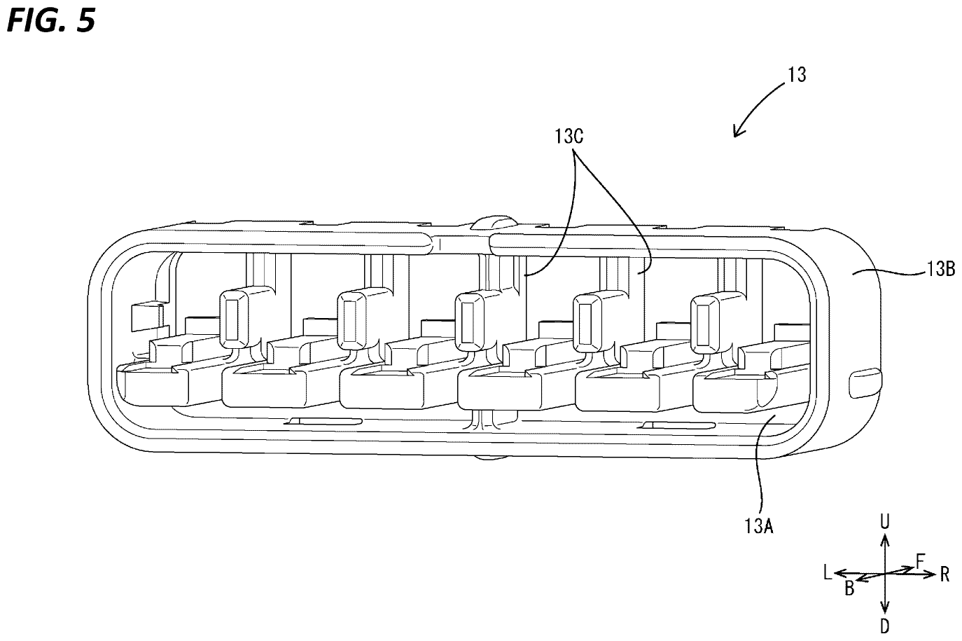

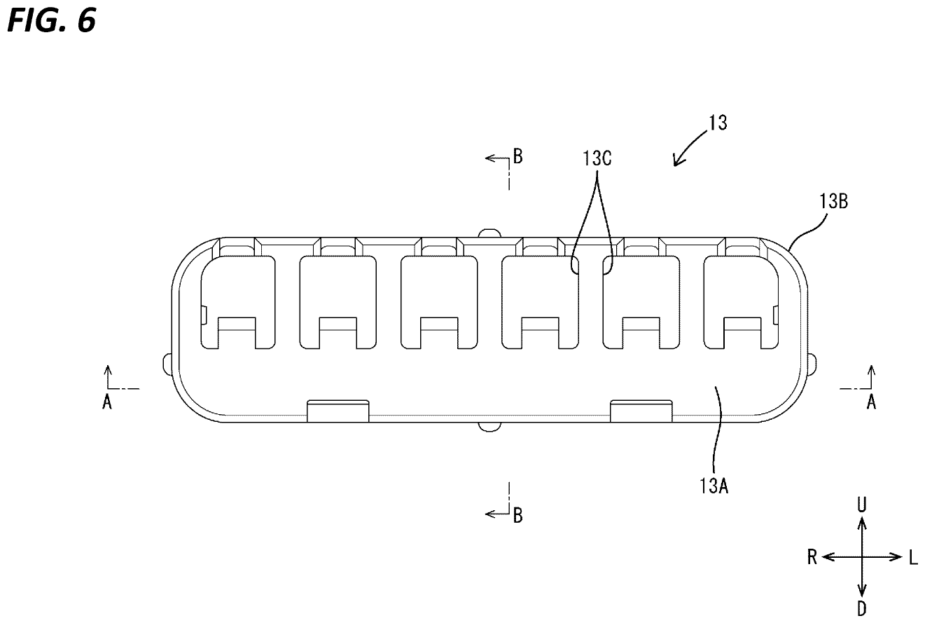

As illustrated in FIGS. 5 and 6, the front retainer 13 has a front wall portion 13A and a peripheral wall portion 13B that protrudes rearward in a tubular shape from an outer peripheral edge of the front wall portion 13A. In a state where the front retainer 13 is attached to the housing body 11A, the front wall portion 13A is disposed to cover a lower portion of the front end of the housing body 11A (see FIG. 10), and the peripheral wall portion 13B is disposed to cover an outer periphery of the front end portion of the housing body 11A (see FIG. 12).

A plurality of window holes 13C corresponding to the cavities 11C are formed to pass through the front wall portion 13A. By inserting the front end portion of the housing body 11A into the window holes 13C, the front end of the housing body 11A and a front surface of the front wall portion 13A are arranged flush with each other (see FIG. 10).

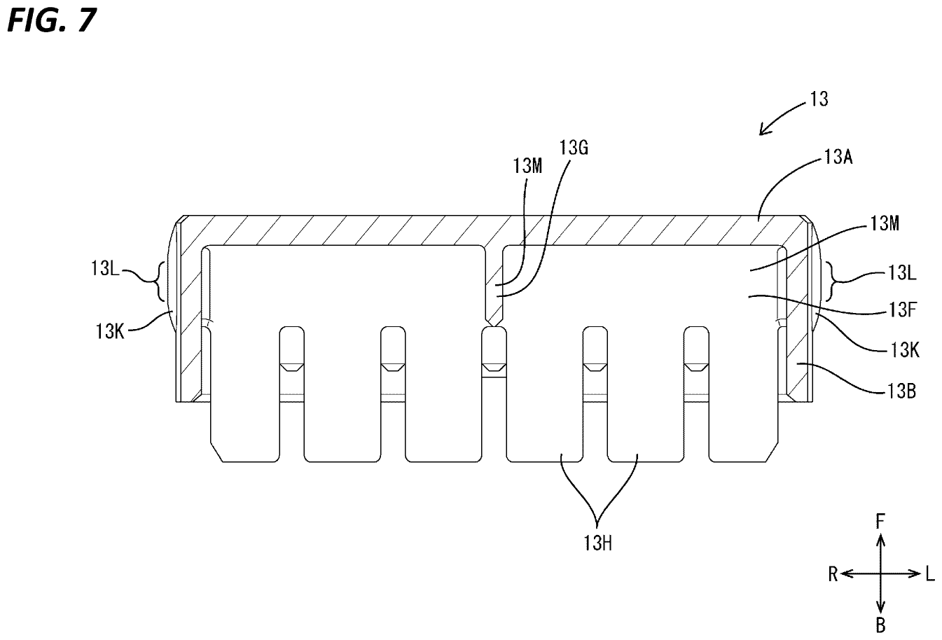

As illustrated in FIGS. 7, 8 and 9, the front retainer 13 has a bridging portion 13M. The bridging portion 13M has a first bridging portion 13F extending in the left-right direction and a second bridging portion 13G extending in the up-down direction. The first bridging portion 13F has a flat shape and disposed with a plate thickness direction thereof oriented in the up-down direction. The first bridging portion 13F extends along and is connected to a rear surface of the front wall portion 13A. Left and right ends of the first bridging portion 13F are respectively connected to a left wall and a right wall (left and right walls) of the peripheral wall portion 13B.

As illustrated in FIG. 7, the first bridging portion 13F is provided with a plurality of retaining portions 13H. The retaining portions 13H are side-by-side in the left-right direction and extend rearward from a rear end edge of the first bridging portion 13F. In a state where the front retainer 13 is properly attached to the housing body 11A, the retaining portion 13H is disposed along a lower surface of a front end portion of the lance 11E (see FIG. 10). Thus, the retaining portion 13H restricts the lance 11E from deflecting downward, and prevents the female terminal fitting 30 disposed in the cavity 11C from coming out of the housing body 11A. The retaining portion 13H is provided individually for each lance 11E.

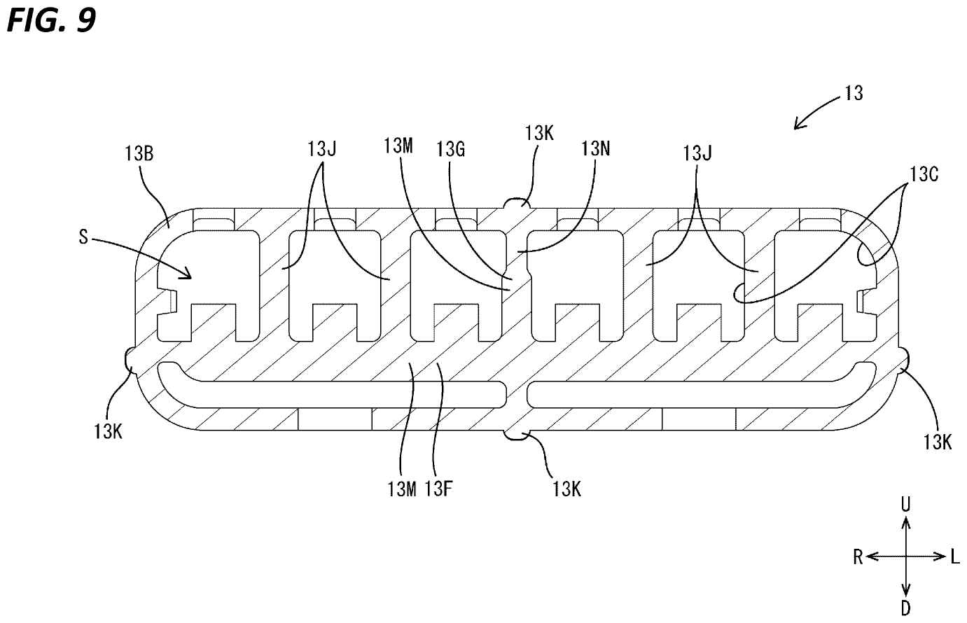

As illustrated in FIGS. 7, 8, and 9, the second bridging portion 13G has a flat shape and is disposed at a left-right center of the front wall portion 13A with the plate thickness direction thereof oriented in the left-right direction. The second bridging portion 13G extends along and is connected to the rear surface of the front wall portion 13A. Upper and lower ends of the second bridging portion 13G are respectively connected to an upper wall and a lower wall (upper and lower walls) of the peripheral wall portion 13B. As illustrated in FIG. 9, two partition walls 13J are arranged on each of left and right sides of the second bridging portion 13G. The partition walls 13J have a flat shape and are arranged to separate adjacent window holes 13C with the plate thickness direction thereof oriented in the left-right direction. The partition walls 13J are formed to connect the upper wall of the peripheral wall portion 13B and the first bridging portion 13F. A rear end of an upper portion of the partition wall 13J is located forward of a rear end of an upper portion of the second bridging portion 13G (see FIG. 11). In other words, a dimension of the upper portion of the partition wall 13J in the front-back direction is shorter than that of the upper portion of the second bridging portion 13G in the front-back direction. An upper end portion of the second bridging portion 13G is formed as a narrow portion 13N that is formed smaller than a width dimension of a lower portion of the second bridging portion 13G (see FIG. 9). A dimension in the left-right direction of the second bridging portion 13G is the same as that of the partition wall 13J except for the narrow portion 13N.

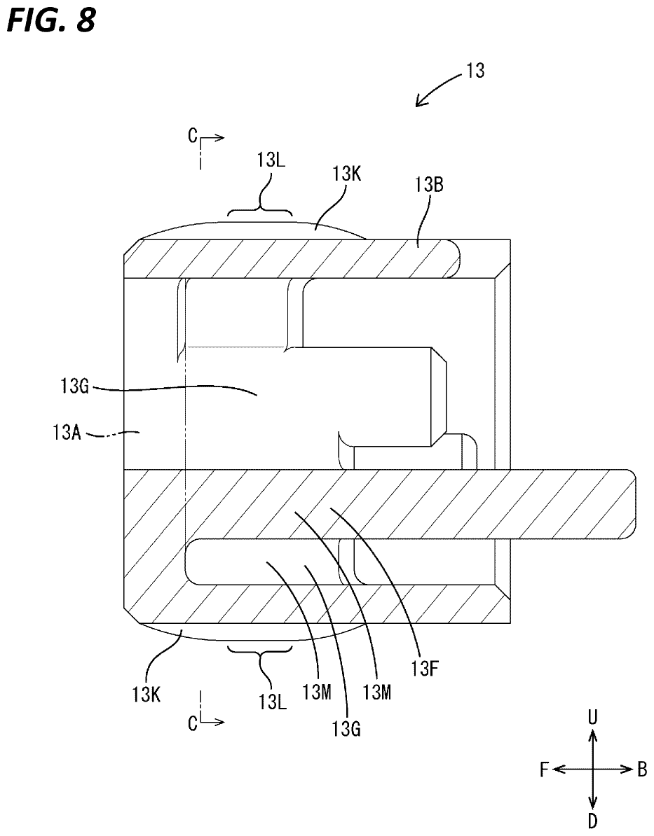

As illustrated in FIGS. 7, 8, and 9, an outer peripheral surface of the peripheral wall portion 13B is provided with a plurality of protrusions 13K that protrude outward. The protrusions 13K are formed extending in the front-back direction. As illustrated in FIGS. 7 and 8, a center portion 13L of each protrusion 13K in the front-back direction is formed parallel to the outer peripheral surface of the peripheral wall portion 13B in the front-back direction. Front and rear end portions of each protrusion 13K are inclined toward the outer peripheral surface of the peripheral wall portion 13B.

As illustrated in FIG. 9, the protrusions 13K on the upper and lower walls of the peripheral wall portion 13B are arranged in a pair at positions facing each other across an internal space S of the peripheral wall portion 13B. The second bridging portion 13G vertically crosses the internal space S of the peripheral wall portion 13B in the up-down direction so as to connect the protrusions 13K provided as a pair on the upper and lower walls of the peripheral wall portion 13B. The second bridging portion 13G has a plate thickness oriented in a direction (left-right direction) intersecting a bridging direction (up-down direction) connecting the protrusions 13K (facing protrusions 13K) provided on the upper and lower walls of the peripheral wall portion 13B. The upper and lower protrusions 13K are continuous in a solid manner in the up-down direction due to the upper and lower walls of the peripheral wall portion 13B and the second bridging portion 13G.

The protrusions 13K provided on the left and right walls of the peripheral wall portion 13B are arranged in a pair at positions facing each other across the internal space S of the peripheral wall portion 13B. The first bridging portion 13F crosses the internal space S of the peripheral wall portion 13B in the left-right direction so as to connect the protrusions 13K provided as a pair on the left and right walls of the peripheral wall portion 13B. The first bridging portion 13F has a plate thickness oriented in a direction (up-down direction) that intersects a bridging direction (left-right direction) connecting the protrusions 13K (facing protrusions 13K) provided on the left and right walls of the peripheral wall portion 13B. The left and right protrusions 13K are continuous in a solid manner in the left-right direction due to the left and right walls of the peripheral wall portion 13B and the first bridging portion 13F.

The peripheral wall portion 13B is provided with two sets of the protrusions 13K provided as a pair, and the bridging portion 13M is provided corresponding to all the sets of the protrusions 13K forming a pair. In the front-back direction, the center portion 13L of the protrusion 13K in the front-back direction is disposed within a range of the length of the first bridging portion 13F and the second bridging portion 13G in the front-back direction (see FIGS. 7 and 8).

### [Assembly Form of Members in Connector]

As illustrated in FIG. 10, in a state where the female terminal fitting 30 is inserted into the cavity 11C from the rear and the front retainer 13 is attached to the housing body 11A from the front, a front end of the lance 11E faces the rear end of the box portion 30A of the female terminal fitting 30. Also, the retaining portion 13H of the front retainer 13 is disposed along the lower surface of the front end portion of the lance 11E. Thus, the retaining portion 13H restricts the lance 11E from deflecting downward, and holds the female terminal fitting 30 disposed in the cavity 11C in a non-removal state.

As illustrated in FIG. 11, in a state where the front retainer 13 is attached to the housing body 11A, the partition wall 13J is inserted from the front into each recess 11F of the housing body 11A. Also, the second bridging portion 13G is inserted from the front into the second receiving recess 11S. In other words, the second bridging portion 13G is disposed between the adjacent first cavity tower 11H and second cavity tower 11J.

In a state where the second housing 12 is assembled to the first housing 11 to which the female terminal fitting 30 and the front retainer 13 are attached, the hood portion 12B is inserted into the fitting space 11D of the first housing 11 from the front of the first housing 11. Also, the lock portion 12C is locked onto the lock arm 11K of the first housing 11 (see FIG. 10). At the same time, the tab 32A of the male terminal fitting 32 is inserted into the box portion 30A from the front of the female terminal fitting 30. The housing body 11A and front retainer 13 are housed in the hood portion 12B of the second housing 12.

As illustrated in FIG. 12, the center portion 13L of the protrusion 13K of the front retainer 13 in the front-back direction contacts the contact portion 12D provided on the inner peripheral surface of the hood portion 12B. In the first housing 11, the first inner contact portions 11M and the second inner contact portions 11N are disposed adjacent to the inner peripheral surface of the peripheral wall portion 13B of the front retainer 13. The first inner contact portions 11M contact the first bridging portion 13F so as to sandwich the first bridging portion 13F in the plate thickness direction (up-down direction) of the first bridging portion 13F at both left and right end portions of the first bridging portion 13F. The second inner contact portions 11N contact the second bridging portion 13G so as to sandwich the second bridging portion 13G in the plate thickness direction (left-right direction) of the second bridging portion 13G at both upper and lower end portions of the peripheral wall portion 13B of the front retainer 13. The second inner contact portions 11N on an upper side contact the narrow portion 13N of the second bridging portion 13G so as to sandwich the narrow portion 13N in the plate thickness direction (left-right direction).

When a direction (up-down direction) in which the protrusions 13K arranged on the upper and lower walls of the peripheral wall portion 13B of the front retainer 13 respectively contact the contact portions 12D on the inner peripheral surface of the hood portion 12B is a first direction, and the left-right direction intersecting the up-down direction is a second direction, the second inner contact portions 11N contact the second bridging portion 13G from the second direction.

When a direction (left-right direction) in which the protrusions 13K arranged on the left and right walls of the peripheral wall portion 13B of the front retainer 13 respectively contact the contact portions 12D on the inner peripheral surface of the hood portion 12B is a first direction, and the up-down direction intersecting the left-right direction is a second direction, the first inner contact portions 11M contact the first bridging portion 13F from the second direction.

Next, operation of the first embodiment will be described.

The connector 10 of the present disclosure includes the first housing 11 and the second housing 12 that are fittable together, and the front retainer 13 that is attached to the first housing 11. The first housing 11 has the housing body 11A that houses the female terminal fitting 30 therein, and the front retainer 13 has the peripheral wall portion 13B that surrounds the outer peripheral surface of the housing body 11A. The second housing 12 has the hood portion 12B that houses the housing body 11A and the front retainer 13 therein. The peripheral wall portion 13B has the plurality of protrusions 13K that contact the inner peripheral surface of the hood portion 12B on the outer peripheral surface thereof. The protrusions 13K are arranged in a pair on the outer peripheral surface of the peripheral wall portion 13B at positions facing each other across the internal space S of the peripheral wall portion 13B. The peripheral wall portion 13B has the bridging portion 13M that extends through the internal space S so as to connect the protrusions 13K forming a pair. With this configuration, the bridging portion 13M is disposed between the protrusions 13K forming a pair, and thus it is possible to avoid a compressive force acting on the peripheral wall portion 13B from the housing body 11A side, which is the side on which the bridging portion 13M is disposed. In addition, the peripheral wall portion 13B can maintain its own rigidity due to the bridging portion 13M between the protrusions 13K provided as a pair. As a result, deflection of the peripheral wall portion 13B can be suppressed.

In the connector 10 of the present disclosure, two sets of the protrusions 13K forming a pair are provided on the peripheral wall portion 13B, and the bridging portion 13M is provided corresponding to all the sets of the protrusions 13K forming a pair. With this configuration, deflection of the peripheral wall portion 13B can be more reliably suppressed.

In the connector 10 of the present disclosure, when the fitting direction of the first housing 11 to the second housing 12 is the front-back direction, the protrusions 13K are arranged within a range of the length of the bridging portion 13M in the front-back direction. With this configuration, a compressive force acting on the peripheral wall portion 13B from the hood portion 12B via the protrusions 13K can be reliably borne by the bridging portion 13M.

In the connector 10 of the present disclosure, when the fitting side of the first housing 11 to the second housing 12 is the front side, the front retainer 13 has the front wall portion 13A that covers the lower portion of the front end of the housing body 11A. The bridging portion 13M extends along the rear surface of the front wall portion 13A and is connected to the rear surface of the front wall portion 13A. With this configuration, the bridging portion 13M is connected to the front wall portion 13A, and thus the strength of the bridging portion 13M can be increased.

In the connector 10 of the present disclosure, the peripheral wall portion 13B has the upper and lower walls and the left and right walls respectively on the upper and lower sides and left and right sides as viewed from the fitting side of the first housing 11 to the second housing 12. The bridging portion 13M has the first bridging portion 13F bridged in the left-right direction between the left and right walls, and the second bridging portion 13G bridged in the up-down direction between the upper and lower walls. With this configuration, a compressive force acting on the peripheral wall portion 13B from the hood portion 12B via the protrusions 13K can be borne by the first bridging portion 13F and the second bridging portion 13G in the left-right direction and the up-down direction, and deflection of the peripheral wall portion 13B can be more reliably suppressed.

In the connector 10 of the present disclosure, the first bridging portion 13F has the retaining portion 13H that prevents the female terminal fitting 30 from coming out of the housing body 11A. With this configuration, the first bridging portion 13F has both a function of reinforcing the front retainer 13 and a function of preventing the female terminal fitting 30 from coming out, and thus it is possible to avoid complicating the configuration of the front retainer 13 compared to a case where both functions are provided separately.

In the connector 10 of the present disclosure, the housing body 11A has the first cavity tower 11H and the second cavity tower 11J adjacent to each other in the left-right direction, and the second installation portion 13G is disposed between the adjacent first cavity tower 11H and second cavity tower 11J. With this configuration, the second bridging portion 13G is disposed between the adjacent first cavity tower 11H and second cavity tower 11J with good space efficiency.

In the connector 10 of the present disclosure, when a direction in which the protrusions 13K contact the inner peripheral surface of the hood portion 12B is a first direction, and a direction intersecting the first direction is a second direction, the first housing 11 has the first inner contact portion 11M and the second inner contact portion 11N that contact the bridging portion 13M from the second direction. With this configuration, the protrusions 13K restrict looseness between the second housing 12 and the front retainer 13, and the first inner contact portion 11M and the second inner contact portion 11N restrict looseness between the first housing 11 and the front retainer 13. As a result, looseness between the first housing 11 and the second housing 12 is restricted through the front retainer 13. In addition, the first direction in which the protrusions 13K contact the inner peripheral surface of the hood portion 12B and the second direction in which the first inner contact portion 11M and the second inner contact portion 11N contact the bridging portion 13M intersect each other. Therefore, an excessive compressive force is not applied to the peripheral wall portion 13B from both sides (first direction and opposite direction thereto) in a thickness direction of the peripheral wall portion 13B, and deflection of the peripheral wall portion 13B can be suppressed.

In the connector 10 of the present disclosure, the bridging portion 13M has a plate shape with a plate thickness oriented in a direction intersecting a bridging direction in which the bridging portion 13M connects the protrusions 13K facing each other, and the first inner contact portion 11M and the second inner contact portion 11N contact the bridging portion 13M so as to sandwich the bridging portion 13M from both sides in a plate thickness direction of the bridging portion 13M. With this configuration, looseness between the first housing 11 and the front retainer 13 can be more reliably suppressed without performing any special processing on the bridging portion 13M.

In the connector 10 of the present disclosure, the first inner contact portion 11M and the second inner contact portion 11N are arranged adjacent to the inner peripheral surface of the peripheral wall portion 13B. With this configuration, since positions where the first inner contact portion 11M and the second inner contact portion 11N contact the bridging portion 13M can be arranged on an outer edge portion of the first housing 11, it is easy to suppress looseness of the front retainer 13 with respect to the first housing 11.

In the connector 10 of the present disclosure, the first housing 11 has the first receiving recess 11P and the second receiving recess 11S that receive the bridging portion 13M between the opposing surfaces 11R facing each other and between the opposing surfaces 11Q facing each other. The first inner contact portion 11M protrudes from each of the opposing surfaces 11Q in a direction that narrows the opening width of the first receiving recess 11P. The second inner contact portion 11N protrudes from each of the opposing surfaces 11R in a direction that narrows the opening width of the second receiving recess 11S. With this configuration, by adjusting the amount by which the first inner contact portion 11M and the second inner contact portion 11N protrude, a looseness prevention structure can be formed between the first housing 11 and the front retainer 13 without increasing assembly resistance.

In the connector 10 of the present disclosure, when the fitting side of the first housing 11 to the second housing 12 is the front side, the attachment member is the front retainer 13 having the front wall portion 13A that covers the front end of the housing body 11A. With this configuration, it is possible to obtain the front retainer 13 that is less likely to deflect.

### [Other Embodiments of Disclosure]

The present disclosure is not limited to the first embodiment described above and illustrated in the drawings. All changes that come within the meaning of equivalency of the claims and fall within the scope of the claims are intended to be embraced in the present invention, and embodiments such as the following are also intended to be embraced therein.

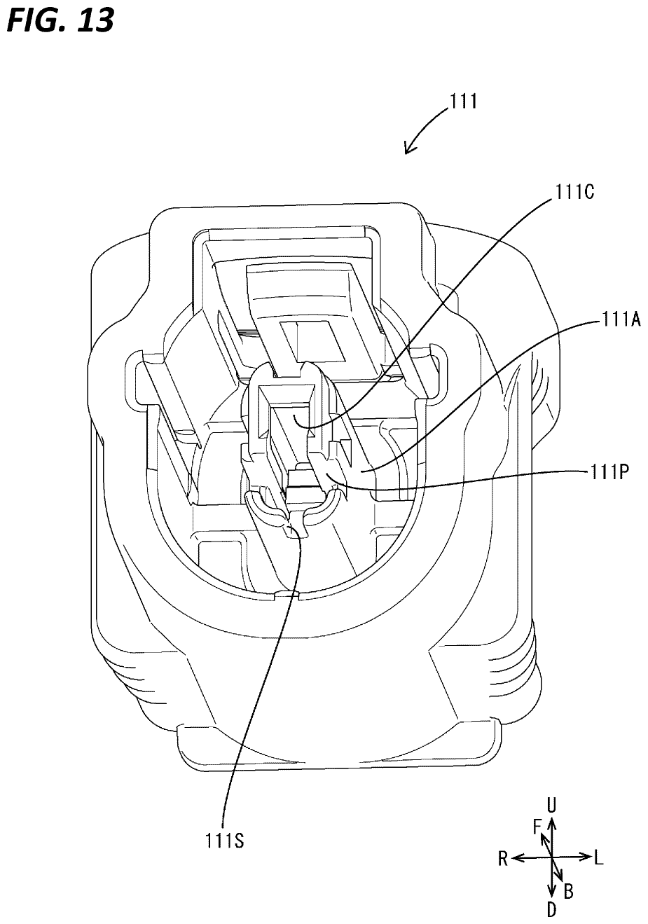

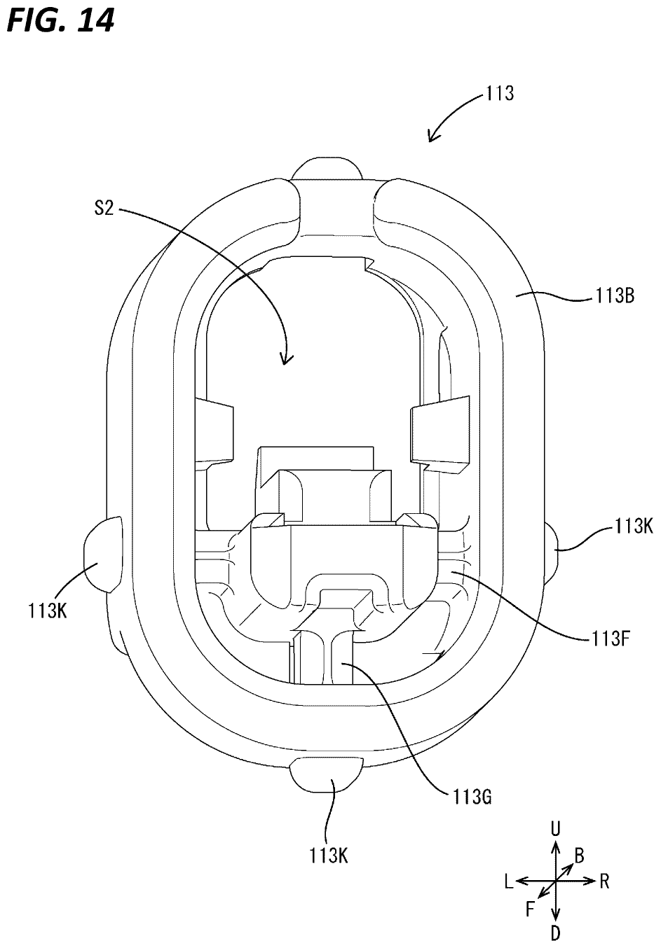

The number of cavities is not limited to the number disclosed in the first embodiment. For example, as illustrated in FIG. 13, a first housing 111 may be configured such that only one cavity 111C is formed in a housing body 111A. In this case, a first receiving recess 111P is formed to pass through the housing body 111A from the left end to the right end. Further, a second receiving recess 111S is formed below the cavity 111C. As illustrated in FIG. 14, a first bridging portion 113F of a front retainer 113, which is the attachment member, crosses an internal space S2 of a peripheral wall portion 113B in the left-right direction so as to connect protrusions 113K provided as a pair on left and right walls of the peripheral wall portion 113B. A second bridging portion 113G is formed connected to a lower wall of the peripheral wall portion 113B and the first bridging portion 113F. The second bridging portion 113G is disposed to be connected to a protrusion 113K provided on the lower wall of the peripheral wall portion 113B.

Unlike the first embodiment, a male terminal fitting may be attached to the first housing.

### LIST OF REFERENCE NUMERALS

10 Connector
11, 111 First housing
11A, 111A Housing body
11B Surrounding wall portion
11C, 111C Cavity
11D Fitting space
11E Lance
11F Recess
11G Connecting portion
11H First cavity tower (Cavity tower)
11J Second cavity tower (Cavity tower)
11K Lock arm
11M First inner contact portion
11N Second inner contact portion
11P, 111P First receiving recess
11Q, 11R Opposing surface
11S, 111S Second receiving recess
12 Second housing
12A Terminal holding portion
12B Hood portion
12C Lock portion
12D Contact portion
13, 113 Front retainer (Attachment member)
13A Front wall portion
13B, 113B Peripheral wall portion
13C Window hole
13F, 113F First bridging portion (Bridging portion)
13G, 113G Second bridging portion (Bridging portion)
13H Retaining portion
13J Partition wall
13K, 113K Protrusion
13L Center portion in direction
13M Bridging portion
13N Narrow portion
16 Seal ring
30 Female terminal fitting
30A Box portion
30B Barrel portion
31 Electric wire
32 Male terminal fitting
32A Tab
33 Rubber stopper
S, S2 Internal space

1. A connector comprising:
a first housing and a second housing that are fittable together; and
an attachment member attached to the first housing,
wherein the first housing has a housing body that houses a terminal fitting therein,
the attachment member has a peripheral wall portion that surrounds an outer peripheral surface of the housing body,
the second housing has a hood portion that houses the housing body and the attachment member therein,
the peripheral wall portion has a plurality of protrusions that contact an inner peripheral surface of the hood portion on an outer peripheral surface thereof,
the protrusions are arranged in a pair at positions facing each other across an internal space of the peripheral wall portion on the outer peripheral surface of the peripheral wall portion, and
the peripheral wall portion has a bridging portion that extends through the internal space so as to connect the protrusions forming a pair.

2. The connector according to claim 1, wherein a plurality of sets of the protrusions forming a pair are provided on the peripheral wall, and the bridging portion is provided corresponding to all the sets of the protrusions forming a pair.

3. The connector according to claim 1, wherein when a fitting direction of the first housing to the second housing is a front-back direction, the protrusions are arranged within a range of a length of the bridging portion in the front-back direction.

4. The connector according to claim 1, wherein
when a fitting side of the first housing to the second housing is a front side, the attachment member has a front wall portion that covers a front end of the housing body, and
the bridging portion extends along a rear surface of the front wall portion and is connected to the rear surface of the front wall portion.

5. The connector according to claim 2, wherein
the peripheral wall portion has upper and lower walls and left and right walls respectively on upper and lower sides and left and right sides as viewed from a fitting side of the first housing to the second housing, and
the bridging portion has a first bridging portion bridged in a left-right direction between the left and right walls, and a second bridging portion bridged in an up-down direction between the upper and lower walls.

6. The connector according to claim 5, wherein the first bridging portion has a retaining portion that prevents the terminal fitting from coming out of the housing body.

7. The connector according to claim 5, wherein
the housing body has cavity towers adjacent to each other in the left-right direction, and
the second bridging portion is disposed between the adjacent cavity towers.

8. The connector according to claim 1 wherein when a direction in which the protrusions contact the inner peripheral surface of the hood portion is a first direction, and a direction intersecting the first direction is a second direction, the first housing has an inner contact portion that contacts the bridging portion from the second direction.

9. The connector according to claim 8, wherein
the bridging portion has a plate shape with a plate thickness oriented in a direction intersecting a bridging direction in which the bridging portion connects the protrusions facing each other, and
the inner contact portion contacts the bridging portion so as to sandwich the bridging portion from both sides in a plate thickness direction of the bridging portion.

10. The connector according to claim 8, wherein the inner contact portion is disposed adjacent to an inner peripheral surface of the peripheral wall portion.

11. The connector according to claim 8, wherein
the first housing has a receiving recess that receives the bridging portion between opposing surfaces facing each other, and
the inner contact portion protrudes from each of the opposing surfaces in a direction that narrows an opening width of the receiving recess.

12. The connector according to claim 1, wherein when a fitting side of the first housing to the second housing is a front side, the attachment member is a front retainer having a front wall portion that covers a front end of the housing body.
